(19) United States
(12) Patent Application Publication
(10) Pub. No.: US 2009/0076821 A1
(43) Pub. Date: Mar. 19, 2009

(54) METHOD AND APPARATUS TO CONTROL OPERATION OF A PLAYBACK DEVICE

(75) Inventors: Vadim Brenner, San Francisco, CA (US); Peter C. DiMaria, Berkeley, CA (US); Dale T. Roberts, San Anselmo, CA (US); Michael W. Mantle, San Rafael, CA (US); Michael W Orme, Emeryville, CA (US)

Correspondence Address: SCHWEGMAN, LUNDBERG & WOESSNER, P.A., P.O. BOX 2938, MINNEAPOLIS, MN, 55402, US

(73) Assignee: GRACENOTE, INC., Emeryville, CA (US)

(21) Appl. No.: 11/884,322

(22) PCT Filed: Aug. 21, 2006
(86) PCT No.: PCT/US2006/032722

§ 371 Date: Oct. 17, 2008

Related U.S. Application Data
(60) Provisional application No. 60/709,560, filed on Aug. 19, 2005.

(51) Int. Cl. G10L 13/08; G06F 17/30

(52) U.S. Cl. 704/260; 707/104.1; 707/1; 707/E17.044; 707/E17.001; 704/E13.001

(57) ABSTRACT

Media metadata is accessible for a plurality of media items (See FIG. 12). The media metadata includes a number of strings to identify information regarding the media items (See FIG. 12). Phonetic metadata is associated the number of strings of the media metadata (See FIG. 12). Each portion of the phonetic metadata is stored in an original language of the string (See FIG. 12).

### CROSS-REFERENCE TO A RELATED APPLICATION

This application claims the benefit of United States Provisional patent application entitled “Method and Apparatus to Control Operation of a Playback Device”, Ser. No. 60/709,560, Filed 19 Aug. 2005, the entire contents of which is herein incorporated by reference.

### TECHNICAL FIELD

This application relates to a method and apparatus to control operation of a playback device. In an embodiment, the method and apparatus may control playback, navigation, and/or dynamic playlisting of digital content using a speech interface.

### BACKGROUND

Digital playback devices such as mobile telephones, portable media players (e.g., MP3 players), vehicle audio and navigation systems, or the like typically have physical controls that are utilized by a user to control operation of the device. For, example, functions such as “play”, “pause”, “stop” and the like provided on digital audio players are in the form of switches or buttons that a user activates in order to enable a selected function. A user typically will press a button (hard or soft) with a finger to select any given function. Further, commands that the devices may receive from a user are limited by the physical size of the user interface comprised of hard and soft physical switches. For example, road navigation products that incorporate speech input and audible feedback may have limited physical controls, display screen area, and graphical user interface sophistication that may not enable easy operation without speech input and/or speaker output.

### BRIEF DESCRIPTION OF DRAWINGS

Some embodiments are illustrated by way of example and not limitation in the figures of the accompanying drawings in which:

FIG. 1 shows system architecture for playback control, navigation, and dynamic playlisting of digital content using a speech interface, in accordance with an example embodiment;

FIG. 2 is a block diagram of a media recognition and management system in accordance with an example embodiment;

FIG. 3 is a block diagram of a speech recognition and synthesis module in accordance with an example embodiment;

FIG. 4 is a block diagram of a media data structure in accordance with an example embodiment;

FIG. 5 is a block diagram of a track data structure in accordance with an example embodiment;

FIG. 6 is a block diagram of a navigation data structure in accordance with an example embodiment;

FIG. 7 is a block diagram of a text array data structure in accordance with an example embodiment;

FIG. 8 is a block diagram of a phonetic transcription data structure in accordance with an example embodiment;

FIG. 9 is a block diagram of an alternate phrase mapper data structure in accordance with an example embodiment;

FIG. 10 is a flowchart illustrating a method for managing phonetic metadata on a database according to an example embodiment;

FIG. 11 is a flowchart illustrating a method for altering phonetic metadata of a database according to an example embodiment;

FIG. 12 is a flowchart illustrating a method for using metadata with an application according to an example embodiment;

FIG. 13 is a flowchart illustrating a method for accessing and configuring metadata for an application according to an example embodiment;

FIG. 14 is a flowchart illustrating a method for accessing and configuring media metadata according to an example embodiment;

FIG. 15 is a flowchart illustrating a method for processing a phrase received by voice recognition according to an example embodiment;

FIG. 16 is a flowchart illustrating a method for identifying a converted text string according to an example embodiment;

FIG. 17 is a flowchart illustrating a method for providing an output string by speech synthesis according to an example embodiment;

FIG. 18 is a flowchart illustrating a method for accessing a phonetic transcription for a string according to an example embodiment;

FIG. 19 is a flowchart illustrating a method for programmatically generating the phonetic transcription according to an example embodiment;

FIG. 20 is a flowchart illustrating a method for performing phoneme conversion according to an example embodiment;

FIG. 21 is a flowchart illustrating a method for converting a phonetic transcription into a target language according to an example embodiment; and

FIG. 22 illustrates a diagrammatic representation of an example machine in the form of a computer system within which a set of instructions, for causing the machine to perform any one or more of the methodologies discussed herein, may be executed.

### DETAILED DESCRIPTION

An example method and apparatus to control operation of a playback device are described. For example, the method and apparatus may control playback, navigation, and/or dynamic playlisting of digital content using speech (or oral communication by a listener). In the following description, for purposes of explanation, numerous specific details are set forth in order to provide a thorough understanding of an embodiment of the present invention. It will be evident, however, to one skilled in the art that the present invention may be practiced without these specific details. Merely by way of example, the digital content may be audio (e.g. music), still pictures/photographs, video (e.g., DVDs), or any other digital media.

Although the invention is described by way of example with reference to digital audio, it will be appreciated to a person of skill in the art that it may be utilized to control the rendering or playback of any digital data or content.

The example methods described herein may be implemented on many different types of systems. For example, one or more of the methods may be incorporated in a portable unit that plays recordings, or accessed by one or more servers processing requests received via a network (e.g., the Internet) from hundreds of devices each minute, or anything in between, such as a single desktop computer or a local area network. In an example embodiment, the method and apparatus may be deployed in portable or mobile media devices for the playback of digital media (e.g., vehicle audio systems, vehicle navigation systems, vehicle DVD players, portable hard drive based music players (e.g., MP3 players), mobile telephones or the like). The methods and apparatus described herein may be deployed as a stand alone device or fully integrated into a playback device (both portable and those devices more suitable to a fixed location (e.g., a home stereo system). An example embodiment allows flexibility in the type of data and associated voice commands and controls that can be delivered to a device or application. An example embodiment may deliver only the commands that the application rendering the audio requires. Accordingly, implementers deploying the method and apparatus in their existing products need only use the generated data they need and that their particular products require to perform the requisite functionality (e.g., vehicle audio system or application running on such a system, MP3 player and application software running on the player, or the like). In an example embodiment, the apparatus and method may operate in conjunction with a legacy automated speech recognition (ASR)/text-to-speech (TTS) solution and existing application features to accomplish accurate speech recognition and synthesis of music metadata.

When used with advanced ASR and/or TTS technology, the apparatus may enable device manufacturers to quickly enable hands-free access to music collections in all types of digital entertainment devices (e.g., vehicle audio systems, navigation systems, mobile telephones, or the like). Pronunciations used for media management may pose special challenges for ASR and TTS systems. In an example embodiment, accommodating music domain specific data may be accomplished with a modest increase in database size. The augmentation may largely stem from the phonetic transcriptions for artist, album, and song names, as well as other media domain specific terms, such as genres, styles, and the like.

An example embodiment provides functions and delivery of phonetic data to a device or application in order to facilitate a variety of ASR and TTS features. These functions can be used in conjunction with various devices, as mentioned by way of example above, and a media database. In an example embodiment, the media database can be accessed remotely for systems with online access or via a local database (e.g., an embedded local database) for non-persistently connected devices. Thus, for example, the local database may be provided in a hard disk drive (HDD) of a portable playback device. In an example embodiment, additional secure content and data may be embedded in a local hard disk drive or in an online repository that can be accessed via the appropriate voice commands along with a Digital Rights Management (DRM) action. For example, a user may verbally request to purchase a track for which access may then be unlocked. The license key and/or the actual track may then be locally unlocked, streamed to the user, downloaded to the user's device or the like.

In an example embodiment, the method and apparatus may work in conjunction with supporting data structures such as genre hierarchies, era/year hierarchies, and origin hierarchies as well as relational data such as related artists, albums, and genres. Regional or device-specific hierarchies may be loaded in so that the supported voice commands are consistent with user expectations of the target market. In addition, the method and apparatus may be configured for one or more specific languages.

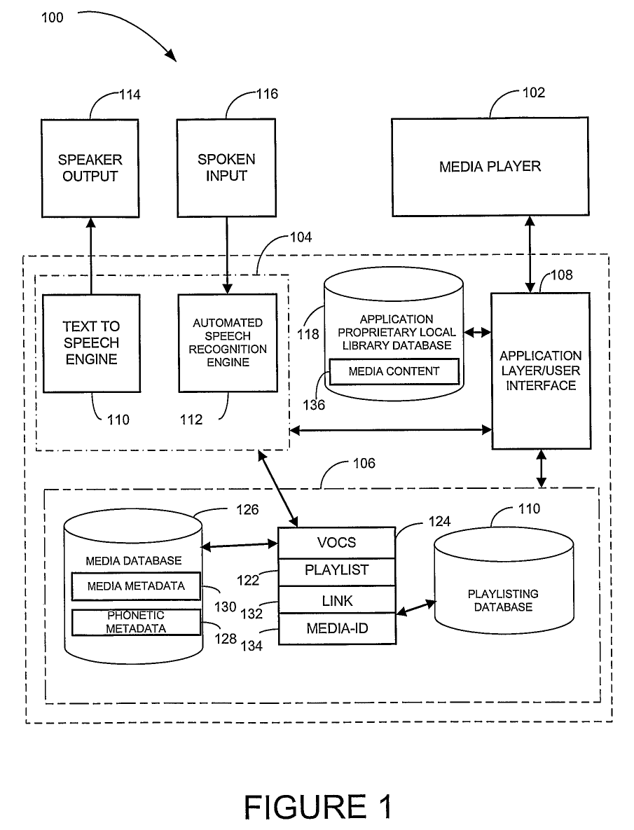

FIG. 1 shows an example high level system architecture 100 for recognition of media content to enable playback control, navigation, media content search, media content recommendations, reading and/or delivering of enhanced metadata (e.g., lyrics and cover art) and/or dynamic playlisting of the media content. The architecture 100 may include a speech recognition and synthesis apparatus 104 in communication with a media management system 106 and an application layer/user interface (UI) 108. The speech recognition and synthesis apparatus 104 may receive spoken input 116 and provide speaker output 114 through speech recognition and speech synthesis respectively. For example, playback control, navigation, media content search, media content recommendations, reading and/or delivering of enhanced metadata (e.g., lyrics and cover art) and/or dynamic playlisting of media content using a text-to-speech (TTS) engine 110 for speech synthesis and an automated speech recognition (ASR) engine 112 for speech recognition commands may allow, for example, navigation functionality (e.g., browse content on a playback device) based on the delivered phonetic metadata 128.

A user may provide the spoken input 116 via an input device (e.g., a microphone) which is then fed into the ASR engine 112. An output of the ASR engine 112 is fed into the application layer/UI 108 which may communicate with the media management system 106 that includes a playlist application layer 122, a voice operation commands (VOCs) layer 124, a link application layer 132, and a media identification (ID) application layer 134. The media management system 106, in turn, may communicate with a media database (e.g., of local or online CDs) 126 and a playlisting database 110.

In an example embodiment, the media ID application layer 134 may be used to perform a recognition process of media content 136 stored in a local library database 118 by use of proper identification methods (e.g., text matching, audio and/or video fingerprints, compact disc Table of Contents TOC, or DVD Table of Programming) in order to persistently associate the media metadata 130 with the related media content. 136

The application layer/user interface 108 may process communications received from a user and/or an embedded application (e.g., within the playback device), while a media player 102 may receive and/or provide textual and/or graphical communications between a user and the embedded application.

In an example embodiment, the media player 102 may be a combination of software and/or hardware and may include one or more of the following: a controls, a port (e.g., universal serial port), a display, a storage, a CD player, a DVD player, an audio file, a storage (e.g., removable, and/or fixed), streamed content (e.g., FM radio and satellite radio), recording capability, and other media. In an example embodiment, the embedded application may interface with the media player 102, such that the embedded application may have access to and/or control of functionality of the media player 102.

In an example embodiment, support for phonetic metadata 128 may be provided in media-ID application layer 134 by including the phonetic metadata 128 in a media data structure. For example, when a CD lookup is successful and the media metadata 130 (e.g., album data) is returned, all phonetic metadata 128 may automatically be included within the media data structure.

The playlist application layer 122 may enable the creation and/or management of playlists within the playlisting database 110. For example, the playlists may include media content as may be contained with the media database 126.

As illustrated, the media database 126 may include the media metadata 130 that may be enhanced to include the phonetic metadata 128. In an example embodiment, an editorial process may be utilized to provide broad-coverage phonetic metadata 128 to account for any insufficiencies in existing speech recognition and/or speech synthesis systems. For example, by explicitly associating specifically generated phonetic data 128 directly with media metadata 130, the association may assist existing speech recognition and/or speech synthesis systems that cannot effectively process media metadata 130, such as artist, album, and track names, which are not pronounced easily, mispronounced, have nicknames, or not pronounced as they are spelled.

In an example embodiment, the media metadata 130 may include metadata for playback control, navigation, media content search, media content recommendations, reading and/or delivering of enhanced metadata (e.g., lyrics and cover art) and/or dynamic playlisting of media content.

The phonetic metadata 128 may be used by the speech recognition and synthesis apparatus 104 to enable functions to work in conjunction with the other components of a solution and may be used in devices without a persistent Internet connection, devices with an Internet connection, PC applications, and the like.

In an example embodiment, one or more phonetic dictionaries derived from the phonetic metadata 128 of the media database 126 and may be created in part or as a whole in clear-text form or another format. Once completed, the phonetic dictionaries may be provided by the embedded application for use with the speech recognition and synthesis apparatus 104, or appended to existing dictionaries already used by the speech recognition and synthesis apparatus 104.

In an example embodiment, multiple dictionaries may be created by the media management system 106. For example, a contributor (artist) phonetic dictionary and a genre phonetic dictionary may be created for use by the speech recognition and synthesis apparatus 104.

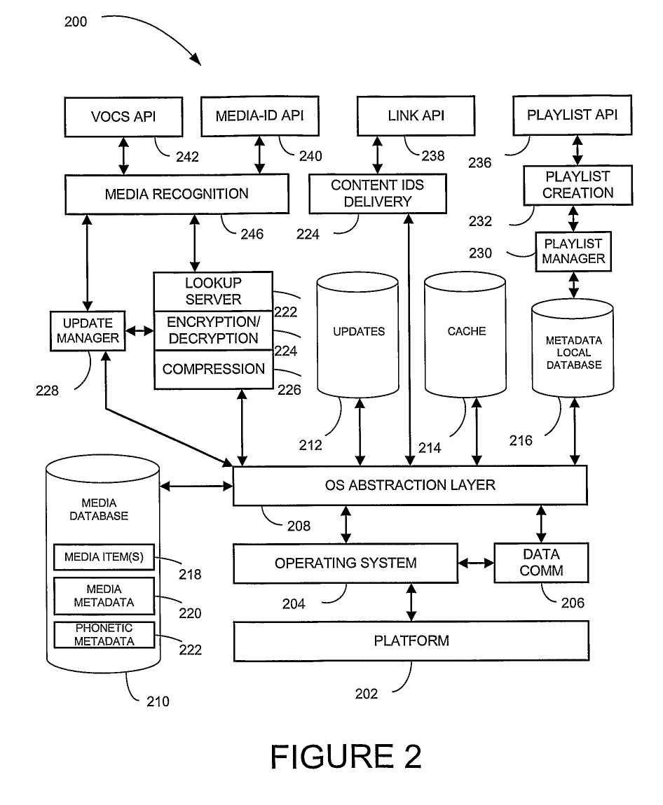

Referring to FIG. 2, an example media recognition and management system 200 is illustrated. In an example embodiment, the media recognition and management system 106 (see FIG. 1) may include the media recognition and management system 200.

The media recognition and management system 200 may include a platform 202 that is coupled to an operating system (OS) 204. The platform 202 may be a framework, either in hardware and/or software, which enables software to run. The operating system 204 may be in communication with a data communication 206 and may further communicate with an OS abstraction layer 208.

The OS abstraction layer 208 may be in communication with a media database 210, an updates database 212, a cache 214, and a metadata local database 216. The media database 210 may include one or more media items 218 (e.g., CDs, digital audio tracks, DVDs, movies, photographs, and the like), which may then be associated with media metadata 220 and phonetic metadata 222. In an example embodiment, a sufficiently robust reference fingerprint set may be generated to identify modified copies of an original recording based on a fingerprint of the original recording (reference recording).

In an example embodiment, the cache 214 may be local storage on a computing system or device used to store data, and may be used in the media recognition and management system 200 to provide file-based caching mechanisms to aid in storing recently queried results that may speed up future queries.

Playlist-related data for media items 218 in a user's collection may be stored in a metadata local database 216. In an example embodiment, the metadata local database 216 may include the playlisting database 110 (see FIG. 1). The metadata local database 216 may include all the information needed during execution of a playlist creation 232 at direction of a playlist manager 230 to create playlist results sets. The playlisting creation 232 may be interfaced through a playlist application programming interface (API) 236.

Lookups in the media recognition and management system 200 may be enabled through communication between the OS abstraction layer 208 and a lookup server 222. The lookup server 222 may be in communication with an update manager 228, an encryption/decryption module 224 and a compression module 226 to effectuate the lookups.

The media recognition module 246 may communicate with the update manager 228 and the lookup server 222 and be used to recognize media, such as by accessing media metadata 220 associated with the media items 218 from the media database 210. In an embodiment, Compact Disks (audio CDs) and/or other media items 218 can be recognized (or identified) by using Table of Contents (TOC) information or audio fingerprints. Once the TOC or the fingerprint is available, an application or a device can then look up the media item 218 for the CD or other media content to retrieve the media metadata 220 from the media database 210. If the phonetic data 222 exists for the recognized media items 218, it may be made available in a phonetic transcription language such as X-SAMPA. The media database 210 may reside locally or be accessible over a network connection. In an example embodiment, a phonetic transcription language may be a character set designed for accurate phonetic transcription (the representation of speech sounds with text symbols). In an example embodiment, Extended Speech Assessment Methods Phonetic Alphabet (X-SAMPA) may be a phonetic transcription language designed to accurately model the International Phonetic Alphabet in ASCII characters.

A content IDs delivery module 224 may deliver identification of content directly to a link API 238, while a VOCs API 242 may communicate with the recognition media module 226 and a media-ID API 240.

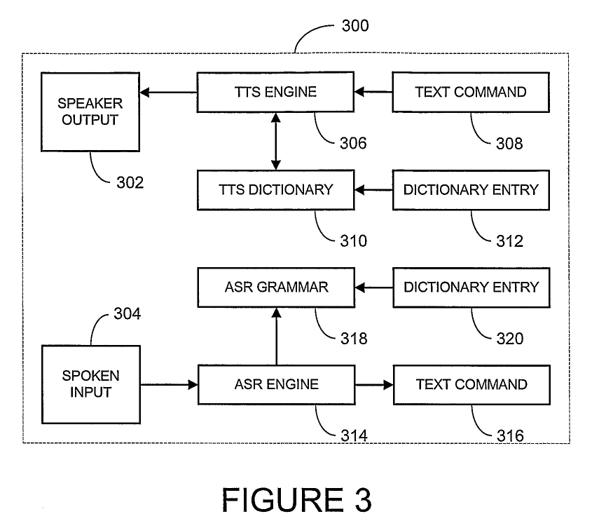

Referring to FIG. 3, an example speech recognition and synthesis apparatus 300 for controlling operation of a playback device is illustrated. In an example embodiment, the speech recognition and synthesis apparatus 104 (see FIG. 1) may include the speech recognition and synthesis apparatus 300. The speech recognition and synthesis apparatus 300 may include an ASR/TTS system.

ASR engine 112 may include speech recognition modules 314, 316, 318, 320, which may know all commands supported by the media management system 106 as well as all media metadata 130, and upon recognition of a command the speech recognition engine 112 may send an appropriate command to a relevant handler (see FIG. 1). For example, if a playlisting application is associated with the embodiment, the ASR engine 112 may send an appropriate command to the playlisting application and then to the application layer/UI 108 (see FIG. 1), which may then execute the request.

Once the speech recognition and synthesis apparatus 300 has been configured with the appropriate data (e.g., phonetic metadata 128, 222 customized for the music domain) the speech recognition and synthesis apparatus 300 may then be ready to respond to voice commands that are associated with the particular domain to which it has been configured. The phonetic metadata 128 may also be associated with the particular device on which it is resident. For example, if the device is a playback device, the phonetic data may be customized to accommodate commands such as “play,” “play again,” “stop,” “pause,” etc.

The TTS engine 110 (see FIG. 1) may include the speech synthesis modules 306, 308, 310, 312. Upon receiving a speech synthesis request, a client application may send the command to be spoken to the TTS engine 110. The speech synthesis modules 306, 308, 310, 312 may first look up a text string to be spoken in its associated dictionary or dictionaries. This phonetic representation of the text string that it finds in the dictionary may then be taken by the TTS engine 306 and the phonetic representation of the text string may be spoken (e.g., create a speaker output 302 of the text string). In an example embodiment, ASR grammar 318 may include a dictionary including all phonetic metadata 128, 222 and commands. It is here that commands such as “Play Artist,” “More like this,” “What is this,” may be defined.

In an example embodiment, the TTS dictionary 310 may be a binary or text TTS dictionary that includes all pre-defined pronunciations. For example, the TTS dictionary 310 may include all phonetic metadata 128, 222 from the media database for the recognized content in the application database. The TTS dictionary 310 need not necessarily hold all possible words or phrases the TTS system could pronounce, as words not in this dictionary may be handled via G2P.

After content recognition and an update of speech recognition and synthesis apparatus 300 functionality has been performed, the user may be able to execute commands for speech recognition and/or speech synthesis. It will however be appreciated that the functionality may be performed in other appropriate ways and is not restricted to the description above. For example, a playback device may be preloaded with appropriate phonetic metadata 128, 222 suitable for the music domain and which may, for example, be updated via the Internet or any other communication channel.

In an example embodiment in which the speech recognition and synthesis apparatus 300 supports X-SAMPA, the phonetic metadata 128, 222 may be provided as is. However, in embodiments in which the speech recognition and synthesis apparatus 300 seeks data in a different phonetic language, the apparatus 300 may include a character map to convert from X-SAMPA to a selected phonetic language.

The speech recognition and synthesis apparatus 300 may, for example, control a playback device in accordance as follows: A spoken input 304 may be a command that is spoken (e.g., an oral communication by a user) into an audio input (e.g., a microphone), such that when a user speaks the command, the associated speech may go into the ASR engine 314. Here, phonetic features such as pitch and tone may be extracted to generate a digital readout of the user's utterance. After this stage, the ASR engine 314 may send features to the search part of the speech recognition and synthesis apparatus 300 for recognition. In a search stage, the ASR engine 314 may match the features it has extracted from the spoken command against the actual commands in its compiled grammar (e.g., a database of reference commands). The grammar may include phonetic data 128, 222 specific to a particular embodiment. The ASR engine 314 may use an acoustic model as a guide for average characteristics of speech for a given or selected language, allowing the matching of phonetic metadata 128, 222 with speech. Here, the ASR engine 314 may either return a matching command or a “fail” message.

In an example embodiment, user profiles may be utilized to train the speech recognition and synthesis apparatus 300 to better understand the spoken commands of a given individual so as to provide a higher rate of accuracy (e.g., a higher rate of accuracy in recognizing domain specific commands). This may be achieved by the user speaking a specific set of text strings into the speech recognition and synthesis apparatus 300, which are pre-defined and provided by the ASR system developer. For example, the text strings may be specific to the music domain.

Once a matching command has been found, the ASR engine 314 may produce a result and send a command to an embedded application. The embedded application can then execute the command.

The TTS engine 306 may take a text (or phonetic) string and process into it into speech. The TTS engine 306 may receive a text command and, for example, using either G2P software or by searching a precompiled binary dictionary (equipped with provided phonetic metadata 128, 222), the TTS engine 306 may process the string. It will be appreciated the TTS functionality may also be customized to a specific domain (e.g., the music domain). The TTS result may “speak” the string (create a speaker output 302 corresponding to the text).

In an example embodiment, along with the metadata, a list of typical voice command and control functions may also provided. These voice commands and control functions may be added to the default grammar for recompilation at runtime, at initialization or during development. A list of example command and control functions (Supported Functions) is provided below.

In an embodiment, while a grammar may be used and updated for speech recognition, a binary or a text dictionary may be needed for speech synthesis. Any text string may be passed to the TTS engine 306, which may speak the string using G2P and the pronunciations provided for it by the TTS dictionary 310.

In an example embodiment, the speech recognition and synthesis apparatus 300 may support Grapheme to Phoneme (G2P) conversion, which may dynamically and automatically convert a display text into its associated phonetic transcription through a G2P module(s). G2P technology may take as input a plain text string provided by application and generate an automatic phonetic transcription.

Users may, for example, control basic playback of music content via voice using ASR technology within an embedded device or with bundled products for the device that include recognition, management, navigation, playlisting, search, recommendation and/or linking to third party technology. Users may navigate and select specific artists, albums, and songs using speech commands.

For example, using the speech recognition and synthesis apparatus 300, users may dynamically create automatic playlists using multiple criteria such as genre, era, year, region, artist type, tempo, beats per minute, mood, etc., or can generate seed-based automatic playlists with a simple spoken command to create a playlist of similar music. In an example embodiment, all basic playback commands (e.g., “Play,” “Next,” “Back,” etc.) may be performed via voice commands. In addition, text-to-speech may also provide with commands like “More like this” or “What is this?” or any other domain specific commands. It will thus be appreciated that the speech recognition and synthesis apparatus 300 may facilitate and enhance the type and scope of commands that may be provided to a playback device such as an audio playback device by using voice commands.

A table including examples of example voice commands that may be supported by the apparatus is shown below.

TABLE 1
Example Voice Commands

| | | |
|---|---|---|
| Function | Example | Command |

Music Recognition

| | | |
|---|---|---|
| Basic Controls | | |
| Play | “Play” | Play |
| Stop | “Stop” | Stop |
| Skip Track | “Next” | Next |
| Prior Track | “Back” | Back |
| Pause | “Pause” | Pause |
| Repeat Track | “Repeat/Play it Again” | Repeat |
| Content Item Playback | | |
| Track Play | “Play Song/Track” <Summer in the City> | Play Song |
| Album Play | “Play Album” <Exile on Main Street> | Play Album |
| Disambiguation | | |
| Play Other Artist/Album/Song/Etc. | “Play Other <Nirvana>” | Play Other |
| Identify Content (w/TTS of textual content) | | |
| Identify Song and Artist | “What is This?” | What is This? |
| Identify Artist | “Artist Name?” | Artist Name? |
| Identify Album | “Album Name?” | Album Name? |
| Identify Song | “Song Name?” | Song Name? |
| Identify Genre | “Genre Name?” | Genre Name? |
| Identify Year | “What Year is This?” | What Year is This?” |
| Transcribe Lyric Line | “What'd He Say?” | What Did He Say? |
| Custom Metadata Labeling | | |
| Add Artist Nickname | “This Artist Nickname <Beck>” | This Artist Nickname |
| Add Album Nickname | “This Album Nickname <Mellow Gold>” | This Album Nickname |
| Add Sang Nickname | “This Song Nickname <Pay No Mind>” | This Song Nickname |
| Add Alternate Command | Command <This Sucks!> Means <Rating 0>” | Command —Means |
| Add Song Nickname | “This Song Nickname <Pay No Mind>” | This Song Nickname |
| Set System Preferences | | |
| Set preference how to announce all | “Use <Nicknames> for all <artists>” | Use - for all |
| Artists | | |
| Set preference how to announce all | “Use <Nicknames> for all <albums>” | Use - for all |
| Albums | | |
| Set preference how to announce all | “Use <Nicknames> for all <tracks>” | Use - for all |
| Tracks | | |
| Set preference how to announce | “Use <Nicknames> for this <artist>” | Use - for this |
| specific Artists | | |
| Set preference how to announce | “Use <Nicknames> for this <album>” | Use - for this |
| specific Albums | | |
| Set preference how to announce | “Use <Nicknames> for this <track>” | Use - for this |
| specific Tracks | | |

PLAYLISTING

| | | |
|---|---|---|
| Static Playlists | | |
| New Playlist | “New Playlist” <Our Parisian Adventure> | New Playlist |
| Add to Playlist | “Add to” <Our Parisian Adventure> | Add to |
| Delete From Playlist | “Delete From”” <Our Parisian Adventure> | Delete From |
| Single-Factual Criterion Auto-Playlist | | |
| Artist Play | “Play Artist” <Beck> | Play Artist |
| Composer Play | “Play Composer” <Stravinsky> | Play Composer |
| Year Play | “Play Year” <1996> | Play Year |
| Single-Descriptive Criterion Auto-Playlists | | |
| Genre Play | “Play Genre/Style” <Big Band> | Play Genre |
| Era Play | “Play Era/Decade” <80's> | Play Era |
| Artist Type Play | “Play Artist Type” <Female Solo> | Play Artist Type |
| Region Play | “Play Region’ <Jamaica> | Play Region |
| Play in Release Date Order | “Play<Bob Dylan> in >Release Date> Order | Play in Order |
| Play Earliest Release Date Content | “Play Early <Beatles> | Play Early |
| IntelliMix and IntelliMix Focus Variations | | |
| Track IntelliMix | “More Like This” | More Like This |
| Album IntelliMix | “More Like This Album” | More Like This Album |
| Artist IntelliMix | “More Like This Artist” | More Like This Artist |
| Genre IntelliMix | “More Like This Genre” | More Like This Genre |
| Region IntelliMix | “More Like This Region” | More Like This Region |
| “Play The Rest” | | |
| More from Album | “Play This Album” | Play this album |
| More from Artist | “Play This Artist” | Play this artist |
| More from Genre | “Play This Genre” | Play this genre |
| Edit/Adjust Current Auto-Playlist | | |
| Play Older Songs | “Older” | Older |
| Play More Popular | “More Popular” | More Popular |
| Define/Generate & Play New Auto-Playlist | | |
| Decade/Genre Auto PL | “New Mix” <70's Funk> | New Mix |
| Origin/Genre Auto PL | “New Mix” < French Electronica> | New Mix |
| Type/Genre Auto PL | “New Mix” <Female Singer-Songwriters> | New Mix |
| Save Auto-Playlist Definition | | |
| Save User-Defined AutoPL | “Save Mix As” <Darcy's Party Mix>” | Save Mix As |
| Save Auto-PL Results as Fixed PL | “Save Playlist As” <Darcy's Party Mix>” | Save Playlist As |
| Re-Mix/Play Saved Auto-Playlist Definition | | |
| Play User-Defined AutoPL | “Play Mix” <Darcy's Party Mix>” | Play Mix |
| Play Preset AutoPL | “Play Mix” <Rock On, Dude> | Play Mix |
| Explicit Rating | | |
| Rate Track | “Rating 9” | Rating |
| Rate Album | “Rate Album 7” | Rate Album |
| Rate Artist | “Rate Artist 0” | Rate Artist |
| Rate Year | “Rate Year 10” | Rate Year |
| Rate Region | “Rate Region 4” | Rate Region |
| Change User Profile | | |
| Change User | “Sign In <Samantha>” | Sign In |
| Add User (for combo profiles) | “Also Sign In <Evan>” | Also Sign In |
| Descriptor Assignment | | |
| Edit Artist Descriptor | “This Artist Origin <Brazil>” | This Artist Origin |
| Edit Album Descriptor | “This Album Era <50's>” | This Album ERa |
| Edit Song Descriptor | “This Song Genre <Ragtime>” | This Song Genre |
| Assign Artist Similarity | “This Artist Similar <Nick Drake>” | This Artist Similar |
| Assign Album Similarity | “This Album Similar <Bryter Layter>” | This Album Similar |
| Assign Song Similarity | “This Song Similar <Cello Song>” | This Song Similar |
| Create User Defined Playilst Criteria | “Create Tag <Radicall>” | Create Tag |
| Assign User-Defined PL Criteria | “Tag <Radicall>” | Tag |
| Banishing | | |
| Banish Track from all Playback | ‘Never Again” | Never Again |
| Banish Album from all Auto-PLs | “Banish Album” | Banish |
| Banish Artist from Specific AutoPL | “Banish Artist from Mix” | Banish from Mix |

3^{rd} PARTY CONTENT LINKING

| | | |
|---|---|---|
| Related Content Request | | |
| Hear Review | “Review” | Review |
| Hear Bio | “Bio” | Bio |
| Hear Concert Info | “Tour” | Tour |
| Commerce | | |
| Download Track | “Download Track” | Download Track |
| Download Album | “Download Album” | Download Album |
| Buy Ticket | “Buy Ticket” | Buy Ticket |

NAVIGATION

| | | |
|---|---|---|
| Multi-Source (e.g. Local files, Digital AM/FM, | | |
| Satellite Radio, Internet Radio) Search | | |
| Inter-Source Artist Nav | “Find Artist <Frank Sinatra>” | Find Artist |
| Inter-Source Genre Nav | “Find Genre <Reggae>” | Find Genre |
| Similar Content Browsing | | |
| Similar Artist Browse | “Find Similar Artists” | Find Similar Artists |
| Similar Genre Browse | “Find Similar Genres” | Find Similar Genres |
| Similar Playlist Browse | “Find Similar Playlists” | Find Similar Playlists |
| Browsing via TTS Category Name Listing | | |
| Genre Hierarchy Nav | “Browse <Jazz> <Albums>” | Browse |
| Era Hierarchy Nav | “Browse <60's> <Tracks>” | Browse |
| Origin Hierarchy Nav | “Browse <Africa> <Artists>” | Browse |
| Era/Genre Hierarchy Nav | “Browse <40's> <Jazz> <Artists>” | Browse |
| Browse Parent Category | “Up Level” | Up Level |
| Browse Child Category | “Down Level” | Down Level |
| Pre-Set Playlist Nav | “Browse Pre-Sets” | Browse |
| Auto-Playlist Nav | “Browse Playlists” | Browse |
| Auto-Playlist Category Nav | “Browse Driving Playlists” | Browse |
| Similar Origin Nav | “Browse Similar Regions” | Browse |
| Similar Artists Nav | “Browse Similar Artists” | Browse |
| Browsing via 4-Second Audio Preview Listing | | |
| Genre Track Clip Scan | “Scan Motown” | Scan |
| Artist Track Clip Scan | “Scan Pink Floyd” | Scan |
| Origin Track Clip Scan | “Scan Italy” | Scan |
| Pre-Set AutoPL Clip Scan | “Scan Pre-Set <Sunday Morning>” | Scan |
| Similar Tracks Scan | “Scan Similar Tracks” | Scan |

RECOMENDATIONS

| | | |
|---|---|---|
| Track Recommendations | Suggest More Tracks | Suggest More Tracks |
| Album Recommendations | Suggest More Albums | Suggest More Albums |
| Artist Recommendations | Suggest More Artists | Suggest More Artists |

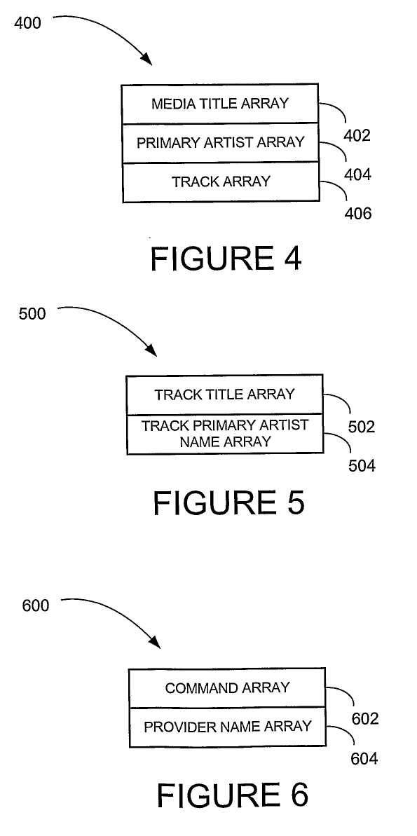

Referring to FIG. 4, an example media data structure 400 is illustrated. In an example embodiment, the media data structure 400 may be used to represent media metadata 130, 220 for media content, such as for the media items 218 (see FIGS. 1 and 2). The media data structure 400 may include a first field with a media title array 402, a second field with a primary artist array 404, and a third field with a track array 406.

The media title array 402 may include an official representation and one or more alternate representations of a media title (e.g., a title of an album, a title of a movie, and a title of a television show). The primary artist name array 404 may include an official representation and one or more alternate representations of a primary artist name (e.g., a name of a band, a name of a production company, and a name of a primary actor). The track array 406 may include one or more tracks (e.g., digital audio tracks of an album, episodes of a television show, and scenes in a movie) for the media title.

By way of an example, the media title array 402 may include “Led Zeppelin IV”, “Zoso”, and “Untitled”, the primary artist name array 404 may include “Led Zeppelin” and “The New Yardbirds”, and the track array 406 may include “Black Dog”, “Rock and Roll”, “The Battle of Evermore”, “Stairway to Heaven”, “Misty Mountain Hop”, “Four Sticks”, “Going to California”, and “When the Levee Breaks”.

In an example embodiment, the media data structure 400 may be retrieved through a successful lookup event, either online or local. For example, media-based lookups (e.g., CD-based lookups and DVD-based lookups) may return media data structures 400 that provide information for every track on a media item, while a file-based lookup may return the media data structure 400 that provides information only for a recognized track.

Referring to FIG. 5, an example track data structure 500 is illustrated. In an example embodiment, each element of the track array 406 (see FIG. 4) may include the track data structure 500.

The track data structure 500 may include a first field with a track title array 502 and a second field with a track primary artist name array 504. The track title array 502 may include an official representation and one or more alternate representations of a track title. The track primary artist name array 504 may include an official representation and one or more alternate representations of a primary artist name of the track.

Referring to FIG. 6, an example command data structure 600 is illustrated. The command data structure 600 may include a first field with a command array 602 and a second field with a provider name array 604. In an example embodiment, the command data structure 600 may be used for voice commands used with the speech recognition and synthesis apparatus 300 (see FIG. 3).

The command array 602 may include an official representation and one or more alternate representations of a command (e.g., navigation control and control over a playlist). The provider name array 604 may include an official representation and one or more alternate representations of a provider of the command. For example, the command may enable navigation, playlisting (e.g., the creation and/or use of one or more play lists of music), play control (e.g., play and stop), and the like.

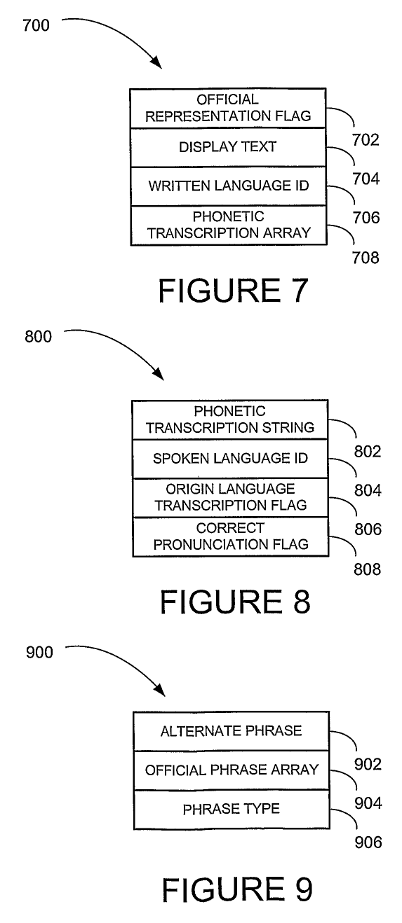

Referring to FIG. 7, an example text array data structure 700 is illustrated. In an example embodiment, the media title array 402 and/or the primary artist array 404 (see FIG. 4) may include the text array data structure 700. In an example embodiment, the track title array 502 and/or the track primary artist name array 504 (see FIG. 5) may include the text array data structure 700. In an example embodiment, the command array 602 and/or the provider name array 604 (see FIG. 6) may include the text array data structure 700.

The example text array data structure 700 may include a first field with an official representation flag 702, a second field with display text 704, a third field with a written language identification (ID) 706, and a fourth field with a phonetic transcription array 708.

The official representation flag 702 may provide a flag for the text array data structure 700 to indicate whether the text array data structure 700 represents an official representation of the phonetic transcript (e.g., an official phonetic transcription) or an alternate representation of the phonetic transcript (e.g., an alternate phonetic transcription). For example, a flag may indicate that a title or name is an official name.

In an example embodiment, the official phonetic transcription may be a phonetic transcription of a correct pronunciation of a text string. In an example embodiment, the alternate phonetic transcription may be a common mispronunciation or alternate pronunciation of a text string. The alternate phonetic transcriptions may include phonetic transcriptions of common non-standard pronunciation of a text string, such as may occur due to user error (e.g., incorrect pronunciation phonetic transcription). The alternate phonetic transcriptions may also include phonetic transcriptions of common non-standard pronunciation of a text string, occurring due to regional language, local dialect, local custom variances and/or general lack of clarity on correct pronunciation (e.g., the phonetic transcriptions of alternate pronunciations).

In an example embodiment, the official representation may be generally associated with a text that appears on an officially released media and/or editorially decided. For example, an official artist name, an album title, and a track title may ordinarily be found on an original packaging of distributed media. In an example embodiment, the official representation may be a single normalized name, in case an artist has changed an official name during a career (e.g., Price and John Mellencamp).

In an example embodiment, the alternate representation may include a nickname, a short name, a common abbreviation, and the like, such as may be associated with an artist name, an album title, a track title, a genre name, an artist origin, and an artist era description. As described in greater detail below, each alternate representation may include a display text and optionally one or more phonetic transcriptions. In an example embodiment, the phonetic transcription may be a textual display of a symbolization of sounds occurring in a spoken human language.

The display text 704 may indicate a text string that is suitable for display to a human reader. Examples of the display text 704 include display strings associated with artist names, album titles, track titles, genre names, and the like.

The written language ID 706 may optionally indicate an origin written language of the display text 704. By way of an example, the written language ID 706 may indicate that the display text of “Los Lonely Boys” is in Spanish.

The phonetic transcription array 708 may include phonetic transcriptions in various spoken languages (e.g. American English, United Kingdom English, Canadian French, Spanish, and Japanese). Each language represented in the phonetic transcription array 708 may include an official pronunciation phonetic transcription and one or more alternate pronunciation phonetic transcriptions.

In an example embodiment, the phonetic transcription array 708 or portions thereof may be stored as the phonetic metadata 128, 222 within the media database 126, 210.

In an example embodiment, the phonetic transcriptions of the phonetic transcription array 708 may be stored using an X-SAMPA alphabet. In an example embodiment, the phonetic transcriptions may be converted into another phonetic alphabet, such as L&H+. Support for a specific phonetic alphabet may be provided as part of a software library build configuration.

The display text 704 may be associated with the official phonetic transcriptions and alternate phonetic transcriptions of the phonetic transcription array 708 by creating a dictionary, which may be provided and used by the speech recognition and synthesis apparatus 300 (see FIG. 3) in advance of a recognition event. In an example embodiment, the display text 704 and associated phonetic transcriptions may be provided on an occurrence of a recognition event.

Phonetic transcriptions of alternate pronunciations, or phonetic variants, of most commonly mispronounced strings for the phonetic metadata 128, 222 may be provided. The alternate pronunciations or phonetic variants may be used to accommodate the automated speech recognition engine 112 to handle many plaintext strings using Grapheme-to-Phoneme technology. However, recognition may be problematic on a few notable exceptions (such as artist names Sade, Beyonce, AC/DC, 311, B-52s, R.E.M., etc.). In addition or instead, an embodiment may include phonetic variants for names commonly mispronounced by users. For example, artists like Sade (e.g., mispronounced /'seId/), Beyonce (e.g., mispronounced /bi.'jans/) and Brian Eno (e.g., mispronounced /'ε._noΩ/).

In an example embodiment, phonetic representations are provided of an alternate name that an artist could be called, thus lessening the rigidity usually found in ASR systems. For example, content can be edited such that the commands “Play Artist: Frank Sinatra,” “Play Artist: Ol'Blue Eyes,” “Play Artist: The Chairman of the Board” are all equivalent.

By way of a series of examples, a first use case may be for the Beach Boys, which may have one phonetic transcription in English that says the “Beach Boys”. A second use case (e.g., for a nickname) may be for Elvis Presley, who has associated with his name a nickname, namely, “The King” or the “King of Rock and Roll”. Each of the strings for the nickname may have a separate text array data structure 700 and have an official phonetic transcription within the phonetic transcription array 708 associated therewith. A third use case (e.g., for a multiple pronunciation) may be for the Eisley Brothers. The Eisley Brothers may have a single text array data structure 700 with a first official phonetic transcription for the Eisley Brothers and a second mispronunciation transcription for the Isley Brothers in the phonetic transcription array 708.

Further with the foregoing example, a fourth use case (e.g., for multiple languages) may have an artist Los Lobos that has a phonetic transcription in Spanish. The phonetic metadata 128 in the media database 126 may be stored in Spanish, the phonetic transcription may be stored in Spanish and tagged accordingly. A fifth use case (e.g., a foreign language in a nickname and a regionalized exception) may include a foreign language nickname, such as Elvis Presley's nickname of “Mao Wong” in China. The phonetic transcription for the nickname may be stored as Mao Wong and the phonetic transcription may be associated with the Chinese language. A sixth use case (e.g., mispronunciation regionalized exception) may be for ACDC. AC/DC may have an associated official transcription in English that is AC/DC, and a French transcription for ACDC that will be provided when the spoken language is French.

Referring to FIG. 8, an example phonetic transcription data structure 800 is illustrated. In an example embodiment, each element of the phonetic transcription array 708 (see FIG. 7) may include the phonetic transcription data structure 800. For example, phonetic transcriptions may include the phonetic transcription data structure 800.

The phonetic transcription data structure 800 may include a first field with a phonetic transcription string 802, a second field with a spoken language ID 804, a third field with an origin language transcription flag 806, and a fourth field with a correct pronunciation flag 808.

The phonetic transcription string 802 may include a text string of phonetic characters used for pronunciation. For example, the phonetic transcription string 802 may be suitable for use by an ASR/TTS system.

In an example embodiment, the phonetic transcription string 802 may be stored in the media database 126 in a native spoken language (e.g., an origin language of the phonetic transcription string 802).

In an example embodiment, an alphabet used for the string of phonetic characters may be stored in a generic phonetic language (e.g., X-SAMPA) that may be translated to ASR and/or TTS system specific character codes. In an example embodiment, an alphabet used for the string of phonetic characters may be L&H+.

The spoken language ID 804 may optionally indicate an origin spoken language of the phonetic transcription string 802. For example, the spoken language ID 804 may indicate that the phonetic transcription string 802 captures how a speaker of a language identified by the spoken language ID 804 may utter an associated display text 704 (see FIG. 7).

The origin language transcription flag 806 may indicate if the transcription corresponds to the written language ID 706 of the display text 704 (see FIG. 7). In an example embodiment, the phonetic transcription may be in an origin language (e.g., a language in which the string would be spoken) when the phonetic transcription is in a same language as the display text 704.

The correct pronunciation flag 808 may indicate whether the phonetic transcription string 802 represents a correct pronunciation in the spoken language identified by the spoken language ID 804.

In an example embodiment, a correct pronunciation may be when a pronunciation it is generally accepted by speakers of a given language as being correct. Multiple correct pronunciations may exist for a single display text 704, where each such pronunciation represents the “correct” pronunciation in a given spoken language. For example, the correct pronunciation for “AC/DC” in English may have a different phonetic transcription (ay see dee see) from the phonetic transcription for the correct pronunciation of “AC/DC” in French (ah say deh say).

In an example embodiment, a mispronunciation may be when a pronunciation it is generally accepted by speakers of a given language as being mispronounced. Multiple mispronunciations can exist for a single display text 704, where each such pronunciation may represent the mispronunciation in a given spoken language. For example, the incorrect pronunciation phonetic transcriptions may be provided to an embedded application in the cases where the mispronunciations are common enough that their utterance by users is relatively likely.

In an example embodiment, to retrieve the phonetic transcriptions (e.g., for correct pronunciations and mispronunciations) in the target spoken language for a representation (e.g., an artist name, a media title, etc.), a phonetic transcription array 708 (see FIG. 7) of a representation may be traversed, the target phonetic transcription strings 802 may be retrieved, and the correct pronunciation flag 808 of each phonetic transcription may be queried.

In an example embodiment, data from the media data structure 400 including display text 704, the phonetic transcriptions of the phonetic transcription array 708, and optionally the spoken language IDs 804 may be used to populate the grammar 318 and the dictionaries 310 (and optionally other dictionaries) for the speech recognition and synthesis apparatus 300 (see FIG. 3).

Referring to FIG. 9, an example alternate phrase mapper data structure 900 is illustrated. The alternate phrase mapper data structure 900 may include a first field with an alternate phrase 902, a second field with an official phrase array 904 and a third field with a phrase type 906. The alternate phrase mapper data structure 900 may be used to support an alternate phrase mapper, the use of which is described in greater detail below.

The alternate phrase 902 may include an alternate phrase to an official phrase, where a phrase may refer to an artist name, a media or track title, a genre name, a description (of an artist type, artist origin, or artist era), and the like. The official phrase array 904 may include one or more official phrases associated with the alternate phrase 902.

For example, alternate phrases may include nicknames, short names, abbreviations, and the like that are commonly known to represent a person, album, song, genre, or era which has an official name. Contributor alternate names may include nicknames, short names, long names, birth names, acronyms, and initials. A genre alternate name may include “rhythm and blues” where the official name is “R&B”. Each artist name, album title, track title, genre name, and era description for example may potentially have one or more alternate representations (e.g., an alternate phonetic transcription for the alternate phrase) aside from its official representation (e.g., an official phonetic transcription for the alternate phrase).

In an example embodiment, the phonetic transcription for the alternate phrase may be a phonetic transcription of a text string that represents an alternative name to refer to another name (e.g., a nickname, an abbreviation, or a birth name).

In an example embodiment, the alternate phrase mapper may use a separate database, whereupon each successful lookup the alternate phrase mapper database may be automatically populated with the alternate phrase mapper data structures 900 mapping alternate phrases (if any exist in the returned media data) to official phrases.

In an example embodiment, phonetic transcriptions for alternate phrases may be stored as dictionaries (e.g., a contributor phonetic dictionary and/or a genre phonetic dictionary) within the dictionary entry 320 of a speech recognition and synthesis apparatus 300 to enable a user to speak an alternate phrase as an input instead of the official phrase (see FIG. 3). The use of the dictionaries may enable the ASR engine 314 to match a spoken input 116 to a correct display text 704 (see FIG. 7) from one of the dictionaries. The text command 316 from the ASR engine 314 may then be provided for further processing, such as to VOCs application layer 124 and/or playlist application layer 122 (see FIGS. 1 and 3).

The phrase type 906 may include a type of the phrase, such as may correspond to the media data structure 400 (see FIG. 4). For example, values of the phrase type 906 may include an artist name, an album title, a track title, and a command.

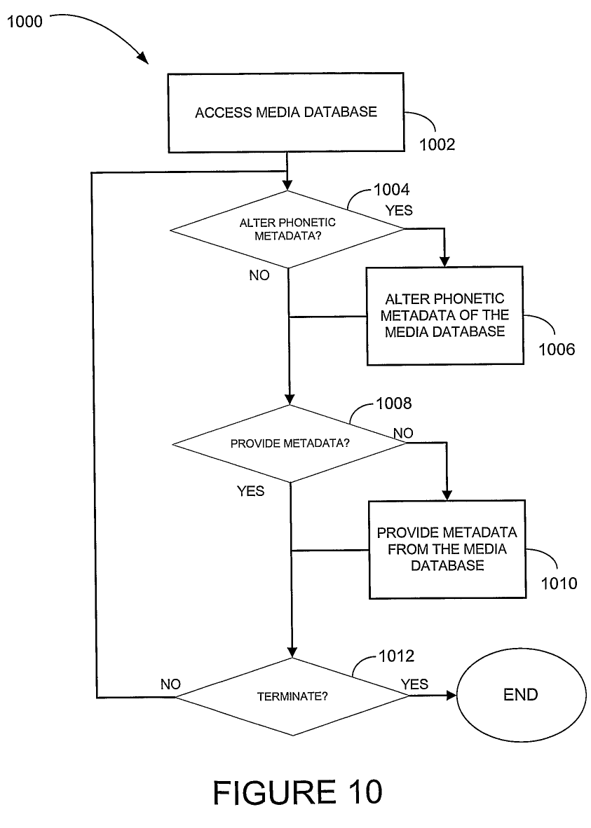

Referring to FIG. 10, a method 1000 for managing phonetic metadata 128, 222 on a database in accordance with an example embodiment is illustrated. In an example embodiment, the database may include the media database 126, 210 (see FIGS. 1 and 2).

The database may be accessed at block 1002. At decision block 1004, a determination may be made as to whether the phonetic metadata 128, 222 will be altered. If the phonetic metadata 128, 222 will be altered, the phonetic metadata 128, 222 is altered at block 1006. An example embodiment of altering the phonetic metadata 128, 222 is described in greater detail below. If the phonetic metadata 128, 222 will not be altered at decision block 1004 or after block 1006, the method 1000 may then proceed to decision block 1008.

A determination may be made at decision block 1008 as to whether metadata (e.g., phonetic metadata 128, 222 and/or media metadata 130, 220) should be provided from the database.

If the metadata is to be provided, the metadata is provided from the database at block 1010. In an example embodiment, providing the metadata may include providing requested metadata for the data to the local library database 118 (see FIG. 1).

In an example embodiment, the phonetic metadata 128 for regional phonetic transcriptions may be provided from and/or to the database and may be stored in a native spoken language of a target region.

In an example embodiment, providing the metadata at block 1010 may include analyzing a music library of an embedded application to determine the accessible digital audio tracks and create a contributor/artist phonetic dictionary and a generic phonetic dictionary with the speech recognition and synthesis apparatus 300 (see FIG. 3). For example, the phonetic metadata 128, 222 for all associated spoken languages that may be supported for a given application may be received and stored for use by an embedded application at block 1010.

If the metadata is not to be provided at decision block 1008 or after block 1010, the method 1000 may proceed to decision block 1012 to determine whether to terminate. If the method 1000 is to continue operating, the method 1000 may return to decision block 1004; otherwise the method 1000 may terminate.

In an example embodiment, the metadata may be provided in real-time at block 1010 whenever a recognition event occurs, such as by interesting a CD in a device running the embedded application, upload a file for access by the embedded, the command data for music navigation is acquired, and the like. In an example embodiment, providing phonetic metadata 128, 222 dynamically may reduce search time for matching data within an embedded application.

In an example embodiment, alternate phrase data used by an alternate phrase mapper may be provided in the same manner as the phonetic metadata 128, 222 at block 1010. For example, the alternate phrase data may automatically be a part of the media metadata 130, 220 that is returned by a successful lookup.

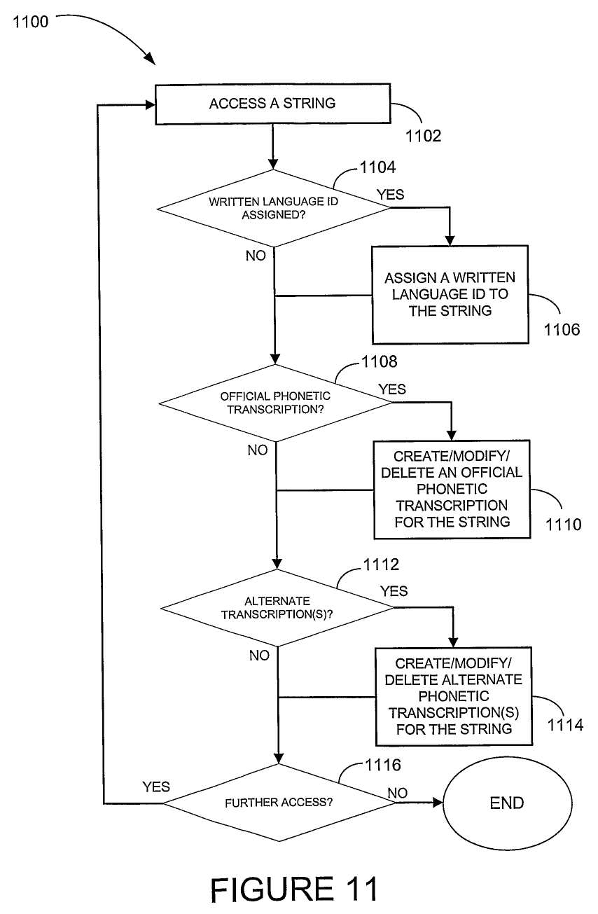

Referring to FIG. 11, a method 1100 for altering phonetic metadata of a database in accordance with an example embodiment is illustrated. The method 1100 may be performed at block 1002 (see FIG. 10). In an example embodiment, the database may include the media database 126, 210 (see FIGS. 1 and 2). A string may be accessed at block 1102, such as from among a plurality of strings contained within the fields of the media metadata 220. In an example embodiment, the string may describe an aspect of the media item 218 (see FIG. 2). For example, the string may be a representation of a media title of the media title array 402, a representation of a primary artist name of the primary artist name array 404, a representation of a track title of the track title array 502, a representation of a primary artist name of the track primary artist name array 504, a representation of a command of the command array 602, and/or a representation of a provider of the provider name array 604.

At decision block 1104, a determination may be made as to whether a written language ID 706 (see FIG. 7) should be assigned to the string. If the method 1100 determines that the written language ID 706 of the string should be assigned, the written language ID 706 of the string may be assigned at block 1106. By way of example, Celine Dion may be assigned the spoken language of Canadian French and Los Lobos may be assigned the spoken language of Spanish.

In an example embodiment, the determination of associating a string with the written language ID 706 may be made by a content editor. For example, the determination of associating a string with a written language may be made by accessing available information regarding the string, such as from a media-related website (e.g., AllMusic.com and Wikipedia.com).

If the method 1100 determines that the written language of the string should not be assigned and/or reassigned (e.g., as the string already has a correct written language assigned) at decision block 1104 or after block 1106, the method 1100 may proceed to decision block 1108.

Upon completion of the operation at block 1106, the method 1100 may assign an official phonetic transcription to the string, such as through an automated source that uses processing to generate the phonetic transcription in the spoken language of the string.

The method 1100 at decision block 1108 may determine whether an action should be taken with an official phonetic transcription for the string. For example, the official phonetic transcription may be retained with the phonetic transcription array 708 (see FIG. 7). If an action should be taken within the official phonetic transcription for the string, the official phonetic transcription for the string may be created, modified and/or deleted at block 1110. If the action should not be taken with the official phonetic transcription for the string at decision block 1108 or after block 1110, the method 1100 may proceed to decision block 1112.

At decision block 1112, the method 1100 may determine whether an action should be taken with one or more alternate phonetic transcriptions. For example, one or more of the alternate phonetic transcriptions may be retained with the phonetic transcription array 708. If an action should be taken with the alternate phonetic transcription for the string, the alternate phonetic transcription for the string may be created, modified and/or deleted at block 1114. If an action should not be taken with the official phonetic transcription for the string at decision block 1112 or after block 1114, the method 1100 may proceed to decision block 1116.

In an example embodiment, the alternate phonetic transcriptions may be created for non-origin languages of the string.

In an example embodiment, alternate phonetic transcriptions are not created for each spoken language in which the string may be spoken. Rather, alternate phonetic transcriptions may be created for only the spoken languages in which the phonetic transcription would sound incorrect to a speaker of the spoken language.

The method 1100 at decision block 1116 may determine whether further access is desired. For example, further access may be provided to a current string and/or another string. If further access is desired, the method 1100 may return to block 1102. If further access is not desired at decision block 1116, the method 1100 may terminate.

In an example embodiment, the phonetic transcriptions may undergo an editorial review in supported languages. For example, an English speaker may listen to the English phonetic transcriptions. When transcriptions are not stored in English, the English speaker may listen to the phonetic transcriptions stored in a non-English language and translated into English. The English speaker may identify phonetic transcriptions that need to be replaced, such as with a regionalized exception for the phonetic transcription.

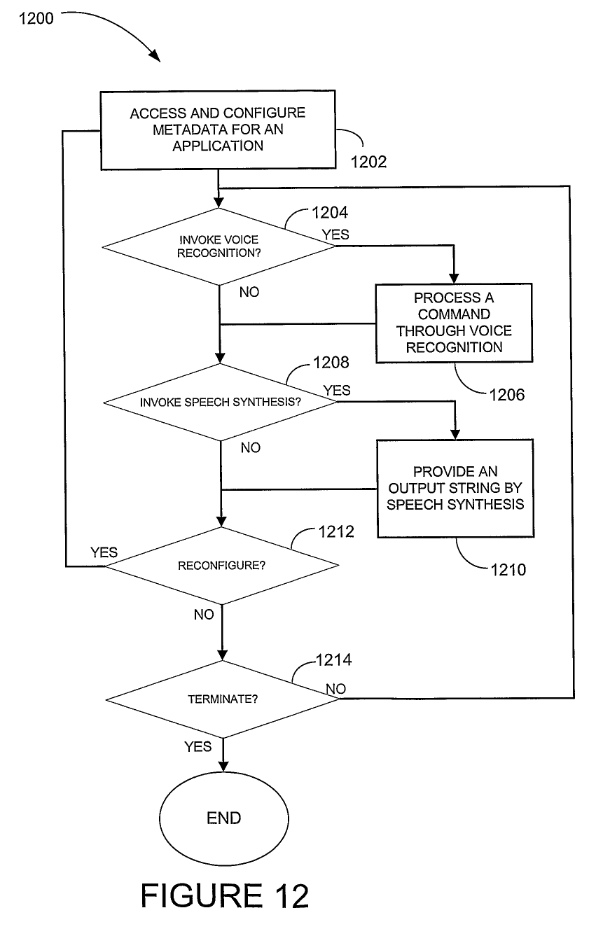

Referring to FIG. 12, a method 1200 for using metadata with an application in accordance with an example embodiment is illustrated. In an example embodiment, the application may be an embedded application. Accordingly, the method 1200 may be deployed and integrated into any audio equipment such as mobile MP3 players, car audio systems, or the like.

Metadata (e.g., phonetic metadata 128, 222 and/or media metadata 130, 220) may be configured and accessed for the application at block 1202 (see FIGS. 1-3). An example embodiment of configuring and accessing metadata for the application is described in greater detail below.

In an example embodiment, after configuring and accessing the metadata, the providing the phonetic metadata 128, 222 for a media item may be reproduced with speech synthesis. In an example embodiment, after configuring and accessing the metadata, the providing the phonetic metadata 128, 222 and/or media metadata 130, 220 may be provided to a third party device during access of the media item.

The method 1200 may re-access and re-configure metadata at block 1202 based on the accessibility of additional media.

At decision block 1204, the method 1200 may determine whether to invoke voice recognition. If the voice recognition is to be invoked, a command may be processed by the speech recognition and synthesis apparatus 300 (see FIG. 3) at block 1206. An example embodiment of a method for processing the command with voice recognition is described in greater detail below. If the voice recognition is not to be invoked at decision block 1204 or after block 1206, the method 1200 may proceed to decision block 1208.

The method 1200 at decision block 1208 may determine whether to invoke speech synthesis. If speech synthesis is to be invoked, the method 1200 may provide an output string through the speech recognition and synthesis apparatus 300 at block 1210. An example embodiment of a method for providing an output string by the speech recognition and synthesis apparatus 300 is described in greater detail below. If speech synthesis is not to be invoked at decision block 1208 or after block 1210, the method 1200 may proceed to decision block 1214.

At decision block 1214, the method 1200 may determine whether to terminate. If the method 1200 is to further operate, the method 1200 may return to decision block 1204; otherwise, the method 1200 may terminate.

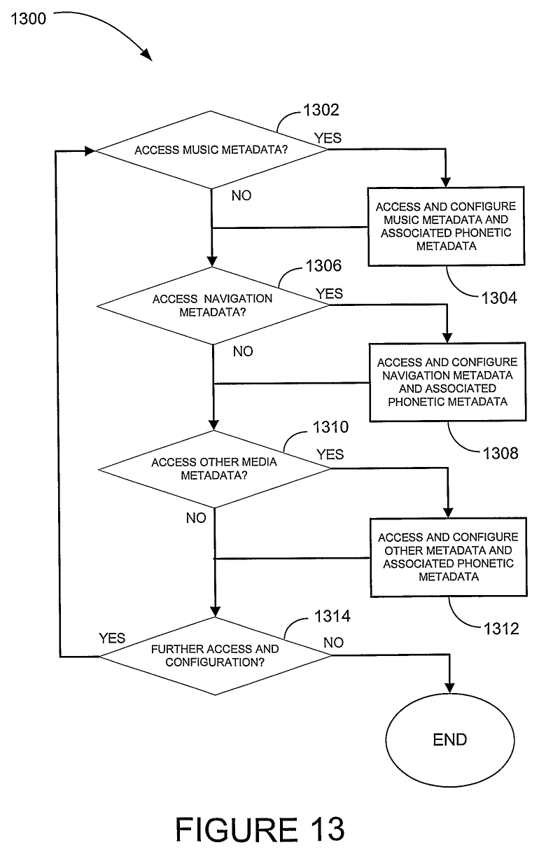

Referring to FIG. 13, a method 1300 for accessing and configuring metadata for an application in accordance with an example embodiment is illustrated. In an example embodiment, the application may be the embedded application. The method 1300 may, for example, be performed at block 1202 (see FIG. 12).

At decision block 1302, the method 1300 may determine whether to access and configure music metadata and the associated phonetic metadata 128, 222 (see FIGS. 1 and 2). If the music metadata and the associated phonetic metadata 128, 222 is to be accessed and configured, the method 1300 may access and configure the music metadata and the associated phonetic metadata 128, 222 at block 1304. An example embodiment of configuring media metadata 130, 220 (e.g., music metadata) is described in greater detail below. If the music metadata and the associated phonetic metadata 128, 222 is not to be accessed and configured at decision block 1302 of after block 1304, the method 1300 may proceed to decision block 1306.

The method 1300 at decision block 1306 may determine whether to access and configure navigation metadata and the associated phonetic metadata 128, 222. If the navigation metadata and the associated phonetic metadata 128, 222 is to be accessed and configured, the method 1300 may access and configure the navigation metadata and the associated phonetic metadata 128, 222 at block 1308. An example embodiment of configuring media metadata 130, 220 (e.g., navigation metadata) is described in greater detail below. If the navigation metadata and the associated phonetic metadata 128, 222 is not to be accessed and configured at decision block 1306 of after block 1308, the method 1300 may proceed to decision block 1310.

At decision block 1310, the method 1300 may determine whether to access and configure other metadata and the associated phonetic metadata 128, 222. If the other metadata and the associated phonetic metadata 128, 222 is to be accessed and configured, the method 1300 may access and configure the other metadata and the associated phonetic metadata 128, 222 at block 1312. An example embodiment of configuring media metadata 130, 220 is described in greater detail below. If the other media metadata and the associated phonetic metadata 128, 22 is not to be accessed and configured at decision block 1310 of after block 1312, the method 1300 may proceed to decision block 1314.

In an example embodiment, the other metadata may include playlisting metadata. For example, users may input their own pronunciation metadata for either a portion of the core metadata or for a voice command, as well as assign genre similarity, ratings, and other descriptive information based on their personal preferences at block 1312. Thus, a user may create his or her own genre, rename The Who as “My Favorite Band,” or even set a new syntax for a voice command. Users could manually enter custom variants using a keyboard or scroll pad interface in the car or by speaking the variants by voice. An alternate solution may enable users to add custom phonetic variants by spelling them out aloud.

The method 1300 may determine whether further access and configuration of the media metadata 130, 220 and associated phonetic metadata 128, 222 is desired at decision block 1314. If further access and configuration is desired, the method may return to decision block 1302. If further access and configuration is not desired at decision block 1314, the method 1300 may terminate.

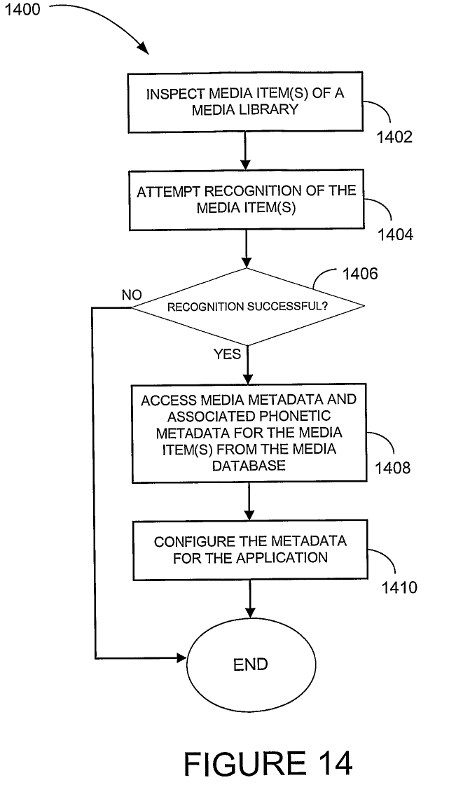

Referring to FIG. 14, a method 1400 for accessing and configuring media metadata for an application in accordance with an example embodiment is illustrated. In an example embodiment, the method 1400 may be performed at block 1304, block 1308 and/or block 1312 (see FIG. 13).

One or more media items (e.g., digital audio tracks, digital video segments, and navigation items) may be accessed from a media library at block 1402. In an example embodiment, the media library may be embodied within the media database 126, 210 (see FIGS. 1 and 2). In an example embodiment, the media library may be embodied within the local library database 118 (see FIGS. 1).

The method 1400 may attempt recognition of the media items at block 1404. At decision block 1406, the method 1400 may determine whether the recognition was successful. If the recognition was successful, the method 1400 may access the media metadata 130, 220 and associated phonetic metadata 128, 222 at block 1408 and configure the media metadata 130, 220 and associated phonetic metadata 128, 222 at block 1410. If the recognition was not successful at decision block 1406 or after block 1410, the method 1400 may terminate.

In an example embodiment, a device implementing the application operating the method 1400 may be used to control, navigate, playlist and/or link music service content which already may contains linked identifiers such as on-demand streaming, radio streaming stations, satellite radio, and the like. Once the content is successfully recognized at decision block 1406, the associated metadata and phonetic metadata 128, 222 may then be obtained at block 1408 and configured for the apparatus at block 1410.

In the example music domain, some artists or groups may share the same name. For example, the 90's rock band Nirvana shares its name with a 70's Christian folk group, and the 90's and 00's California post-hardcore group Camera Obscura shares its name with a Glaswegian Indie pop group. Furthermore, some artists share nicknames with the real names of other artists. For example, Frank Sinatra is known as “The Chairman of the Board,” which is also phonetically very similar to the name of a soul group from the 70's called “The Chairmen of the Board”. Further, ambiguity may result from the rare occurrence that, for example, the user has both Camera Obscura bands on a portable music player (e.g., on hard drive of the player) and the user then instructs the apparatus to “Play Camera Obscura.”

Example methodology may be employed to accommodate duplicate names may be as follows. In an embodiment, selection of artist or album to play may be based upon previous playing behavior of a user or explicit input. For example, assume that the user said “Play Nirvana” having both Kurt Cobain's band and the 70's folk band on the user's playback device (e.g., portable MP3 player, personal computer, or the like). The application may use playlisting technology to check both play frequency rates for each artist and play frequency rates for related genres. Thus, if the user frequently plays early-90's grunge then the grunge Nirvana may be played; if the user frequently plays folk, then the folk Nirvana may be played. The apparatus may allow toggling or switching between a preferred and a non-preferred artist. For example, if the user wants to hear folk Nirvana and gets grunge Nirvana, the user can say “Play Other Nirvana” to switch to folk Nirvana.

In addition or instead, the user may be prompted upon recognition of more than one match (e.g., more than one match per album identification). When, for example, the user says “Play artist Camera Obscura,” the apparatus will find two entries and prompt (e.g., using TTS functionality) the user: “Are you looking for Camera Obscura from California, or Camera Obscura from Scotland?” or some other disambiguating question which uses other items in the media database. The user is then able to disambiguate the request themselves. It will be appreciated that when the apparatus is deployed in a navigation environment, town/city names, street names or the like may also be processed in a similar fashion.

In an example embodiment, where an album series exists where each album has the same name other than a volume number (e.g., the “Vol. X”), any identical phonetic transcriptions may be treated as equivalent. Accordingly, when prompted, the apparatus may return a match on all targets. This embodiment may, for example, be applied to albums such as the “Now That's What I Call Music!” series. In this embodiment, the application may handle transcriptions such that if the user says “‘Play Album’ Now That's What I Call Music,” all matching files found will play, whereas if the user says “‘Play Album’ Now That's What I Call Music Volume Five,” only Volume Five will play. This functionality may also be applied to 2-Disc albums. For example, “Play Album “All Things Must Pass”” may automatically play tracks form both Disc 1 and Disc 2 of the two disc album. Alternatively, if the user says “Play Album “All Things Must Pass” Disc 2,” only tracks from Disc 2 may be played.

In an example embodiment, the device may accommodate custom variant entries on the user side in order to give meaning to terms like “My Favorite Band,” “My Favorite Year,” or “Mike's Surf-Rock Collection.” For example, the apparatus may allow “spoken editing” (e.g., commanding the apparatus to “Call the Foo Fighters “My Favorite Band”). In addition or instead, text-based entry may be used to perform this functionality. As phonetic metadata 128, 222 may be a component of core metadata, a user may be able to edit entries on a computer and then upload them as some kind of tag with the file. Thus, in an embodiment, a user may effectively add user defined commands not available with conventional physical touch interfaces.

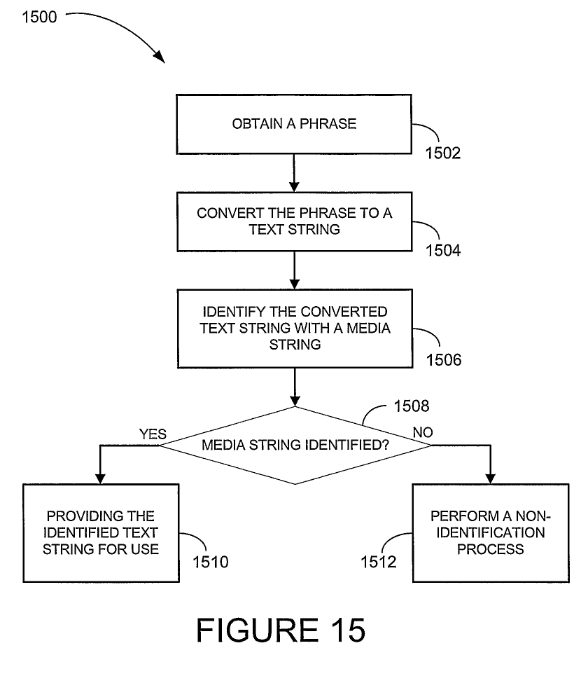

Referring to FIG. 15, a method 1500 for processing a phrase received by voice recognition in accordance with an example embodiment is illustrated. The method 1500 may be performed at block 1206 (see FIG. 12).

A phrase may be obtained at block 1502. For example, the phrase may be received by spoken input 116 through the automated speech recognition engine 112 (see FIG. 1). The phrase may then be converted to a text string at block 1504, such as by use of the automated speech recognition engine 112.

The converted text string may then be identified with a media string at block 1506. An example embodiment of identifying the converted text string is described in greater detail below.

In an example embodiment, a portion of the converted text string may be provided for identification, and the remaining portion may be retained and not provided for identification. For example, a first portion provided for identification may be a potential name of a media item, and second portion not provided for identification may be a command to an application (e.g., “play Billy Idol” may have the first portion of “Billy Idol” and the second portion of “play”).

At decision block 1508, the method 1500 may determine whether a media string was identified. If the media string was identified, the identified text string may be provided for use at block 1510. For example, the phrase may be returned to an application for its use, such that the string may be reproduced with speech synthesis.

If a string was not identified, a non-identification process may be performed at block 1512. For example, the non-identification process may be to take no action, respond with an error code, and/or make taking an intended action with a best guess of the string as the non-identification process. After completion of the operations at block 1510 or block 1512, the method 1500 may terminate.

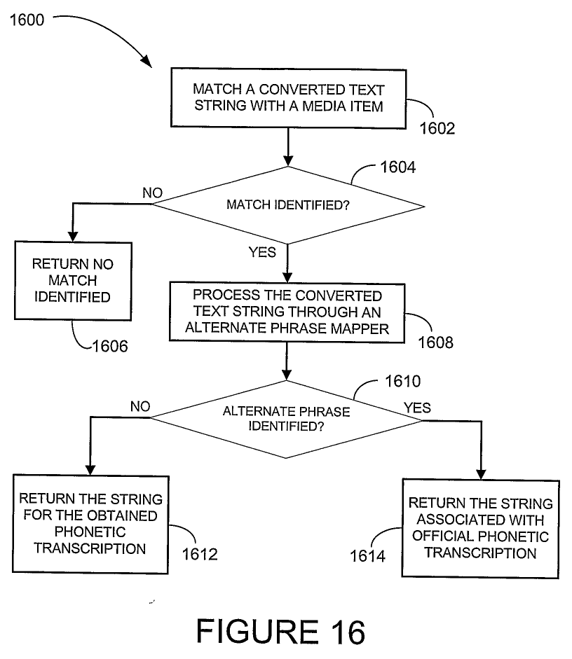

FIG. 16 illustrates a method 1600 for identifying a converted text string in accordance with an example embodiment. In an example embodiment, the method 1600 may be performed at block 1506 (see FIG. 15).

A converted text string may be matched with the display text 704 of a media item at block 1602. At decision block 1604, the method 1600 may determine whether a match was identified. If no match was identified, an indication that no match was identified may be returned at block 1606. If a string match was identified at decision block 1604, the method 1600 may proceed to block 1608.

The converted text string may be processed through an alternate phrase mapper at block 1608. For example, the alternate phrase mapper may determine whether an alternate phrase exists (e.g., may be identified) for the converted text string.

In an example embodiment, the alternate phrase mapper may be used to facilitate the mapping of alternate phrases to their associated official phrase. The alternate phrase mapper may be used within the speech recognition and synthesis apparatus 300 (see FIG. 3), wherein an uttered alternate phrase leads to an official representation of display text 704. For example, if “The Stones” is provided as spoken input 114; the automated speech recognition engine 112 may analyze the phonetics of the uttered name and produce the defined display text 704 of “The Stones” (see FIGS. 1 and 7). “The Stones” may be submitted to the alternate phrase mapper, which would the return the official name “The Rolling Stones”.

In an example embodiment, the alternate phrase mapper may return multiple official phrases in response to a single input alternate phrase since there may be more than one official phrase for the same alternate phrase.

At decision block 1610, the method 1600 may determine whether the alternate phrase has been identified. If the alternate phrase has not been identified, the string for the obtained phonetic transcription may be returned. If the alternated phrase has been identified at decision block 1610, a string associated with an official transcription may be returned. After completion of the operations at block 1612 or block 1614, the method 1600 may terminate.

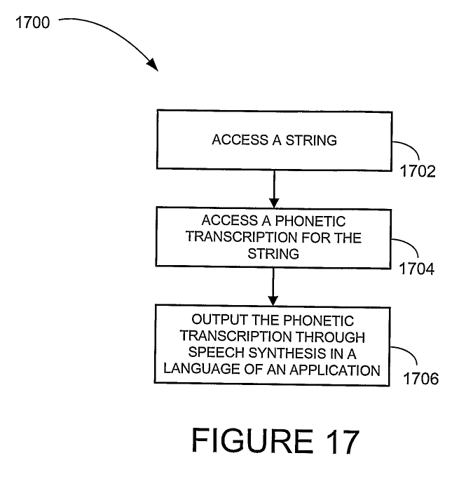

Referring to FIG. 17, a method 1700 for providing an output string by speech synthesis in accordance with an example embodiment is illustrated. In an example embodiment, the method 1700 may be performed at block 1706 (see FIG. 13).

A string may be accessed at block 1702. For example, the accessed string may be a string for which speech synthesis is desired. A phonetic transcription may be accessed for the string at block 1704. For example, a correct phonetic transcription for the spoken language corresponding to the string may be accessed. An example embodiment of accessing the phonetic transcription for the string is described in greater detail below.

In an example, a phonetic transcription for a string may be unavailable, such as within the media database 126 and/or the local library database 118. An example embodiment for creating the phonetic transcription is described in greater detail below.

The phonetic transcription may be outputted through speech synthesis in a language of an application at block 1706. For example, the phonetic transcription may be outputted from the TTS engine 110 as the spoken output 114 (see FIG. 1). After completion of the operation at block 1706, the method 1700 may terminate.

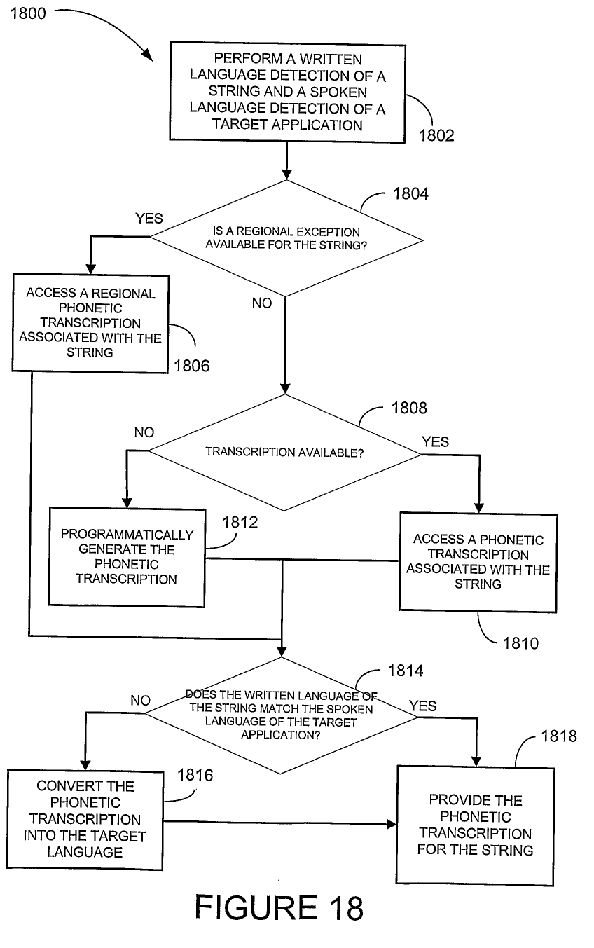

Referring to FIG. 18, a method 1800 for accessing a phonetic transcription for a string in accordance with an example embodiment is illustrated. In an example embodiment, the method 1800 may be performed at block 1704 (see FIG. 18).

A written language detection (e.g., detecting a written language) of a string and a spoken language detection of a target application (e.g., as may be embodied on a target device) may be performed at block 1802. In an example embodiment, the string may be a representation of a media title of the media title array 402, a of a primary artist name of the primary artist name array 404, a representation of a track title of the track title array 502, a representation of a primary artist name of the track primary artist name array 504, a representation of a command of the command array 602, and/or a representation of a provider of the provider name array 604. In an example embodiment, the target application may be the embedded application.

At decision block 1804, the method 1800 may determine whether a regional exception is available for the string. If the regional exception is available, a regional phonetic transcription associated with the string may be accessed at block 1806. In an example embodiment, the regional phonetic transcription may be an alternate phonetic transcription, such as may be due to a regional language, local dialect and/or local custom variances.

Upon completion of block 1806, the method 1800 may proceed to decision block 1814. If the regionalized exception is not available for the string at decision block 1804, the method 1800 may proceed to decision block 1808.

The method 1800 may determine whether a transcription is available for the string at decision block 1808. If the transcription is available, the transcription associated with the string may be accessed at block 1810.

In an example embodiment, the method 1800 at block 1810 may first access a primary transcription that matches the string language when available, and when unavailable may access another available transcription (e.g., an English transcription).

If the transcription is not available for the string at decision block 1808, the method 1800 may programmatically generate a phonetic transcription at block 1812. For example, programmatically generating an alternate phonetic transcription for a regional mispronunciation in the native language of a speaker may use a default G2P already loaded into a device operating the application, such that the received text strings upon recognition of content may be run through a default G2P. An example embodiment of programmatically generating a phonetic transcription is described in greater detail below. Upon completion of the operations at block 1810 and 1812, the method 1800 may proceed to decision block 1814.

At decision block 1814, the method 1800 may determine whether the written language of the string matches the spoken language of the target application. If the written language of the string does not match the spoken language of the target application, the obtained phonetic transcription may be converted into the spoken language of the target application (e.g., the target language) at block 1816. An example embodiment for a method of converting the obtained phonetic transcription is described in greater detail below.

In an example embodiment, phonetic transcriptions at block 1816 may be converted from a native spoken language of the string to a target language of an application operating on the device using phoneme conversion maps.

If the written language of the string matches the spoken language of the target application at decision block 1814 or after block 1816, the phonetic transcription for the string may be provided to the application at block 1818. After completion of the operation at block 1818, the method 1800 may terminate.

In an example embodiment, the method 1800 before conducting the operation at block 1818 may perform a phonetic alphabet conversion to convert the phonetic transcription into a transcription usable by the device. In an example embodiment, the phonetic alphabet conversion may be performed after the phonetic transcription for the string is provided.

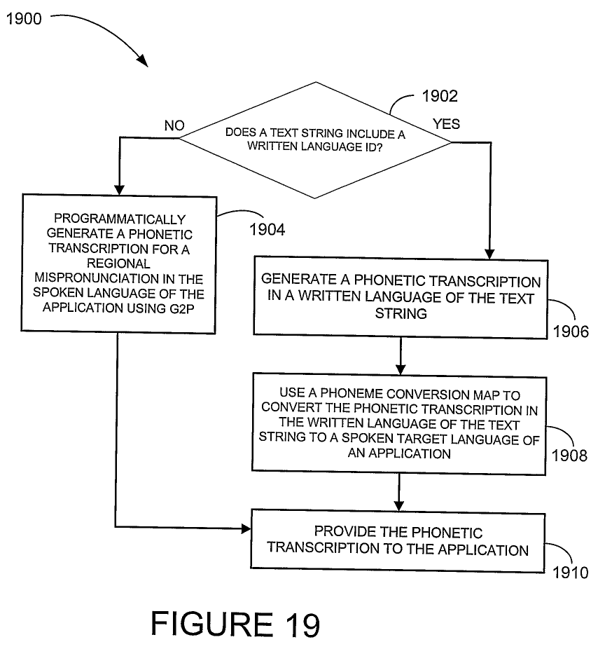

Referring to FIG. 19, a method 1900 for programmatically generating the phonetic transcription is illustrated. In an example embodiment, the method 1900 may be performed at block 1812 (see FIG. 18).

At decision block 1902, the method 1900 may determine whether a text string includes a written language ID 706 (see FIG. 7). If the string includes the written language ID 706, the method 1900 may programmatically generate a phonetic transcription for a regional mispronunciation in a spoken language of an application using G2P at block 1904.

If the text string does not include the written language ID 706 at decision block 1902, a phonetic transcription in a written language of the text string may be generated at block 1906. For example, a language-specific G2P may be used by the speech recognition and synthesis apparatus 300 (see FIG. 3) to generate a phonetic transcription in the written language of the text string.

A phoneme conversion map may be used at block 1908 to convert the phonetic transcription in the written language of the text string to one or more phonetic transcriptions respectively for one or more target spoken languages of an application.

In an example embodiment, conversions of the phonetic transcriptions may be from a single phonetic transcription to multiple phonetic transcriptions.

After completion the operation at block 1904 or block 1910, the method 1900 may provide the phonetic transcription to the application. Upon completion of the operation at block 1920, the method 1900 may terminate.

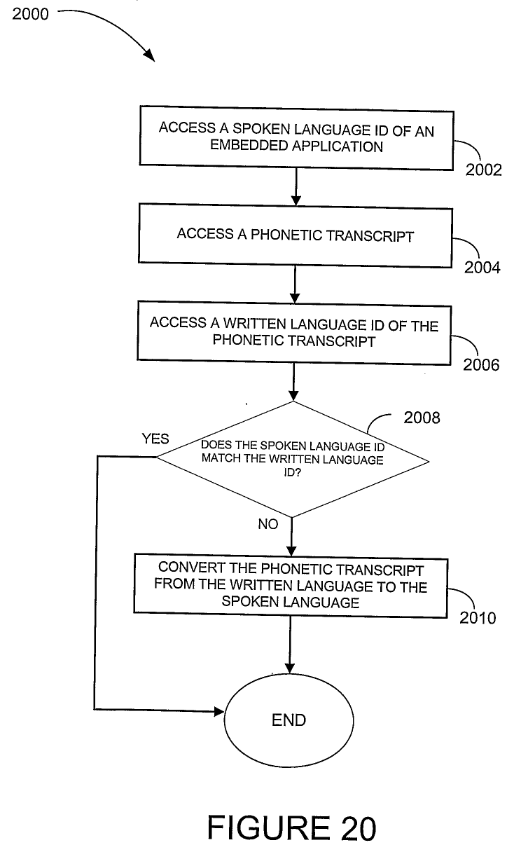

Referring to FIG. 20, a method 2000 for performing phoneme conversion is illustrated. In an example embodiment, the method 2000 may be performed at block 1816 (see FIG. 18).

A spoken language ID 804 (see FIG. 8) of an application (e.g., the embedded application) may be accessed at block 2002. In an example embodiment, the spoken language ID 804 of the application may be pre-set. In an example embodiment, the spoken language ID 804 of the application may be modifiable, such that a language of the embedded application may be selected.

A phonetic transcript may be accessed at block 2004, and thereafter a written language ID 706 (see FIG. 7) for the phonetic transcript may be accessed at block 2006.

At decision block 2008, the method 2000 may determine whether the spoken language ID 804 of the embedded application matches the written language ID 706 of the phonetic transcript. If there is not a match, the method 2000 may convert the phonetic transcript from the written language to the spoken language at block 2010. If the spoken language ID 804 does not match the written language ID 706 at decision block or after block 2010, the method 2000 may terminate.

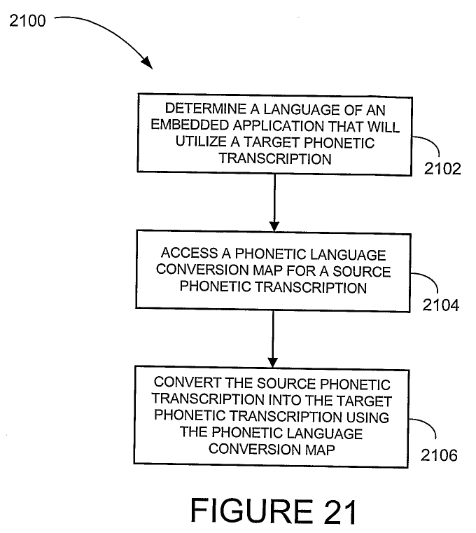

Referring to FIG. 21, a method 2100 for converting a phonetic transcription into a target language in accordance with an example embodiment is illustrated. In an example embodiment, the method 2100 may be performed at block 2010 (see FIG. 20).

A language of an embedded application (e.g., a target application) that will utilize a target phonetic transcription may be determined at block 2102. A phonetic language conversion map may be accessed for a source phonetic transcription at block 2104. In an example embodiment, phonetic language conversion map may be a phoneme conversion map.

The source phonetic transcription may be converted into the target phonetic transcription using the phonetic conversion map at block 2106. After completion of the operation at block 2106, the method 2100 may terminate.

In an example embodiment, a character mapping between a generic phonetic language and a phonetic language used by the speech recognition and synthesis apparatus 300 (see FIG. 3) may be created and used with the media management system 106. Upon completion of the operation at block 2106, the method 2100 may terminate.

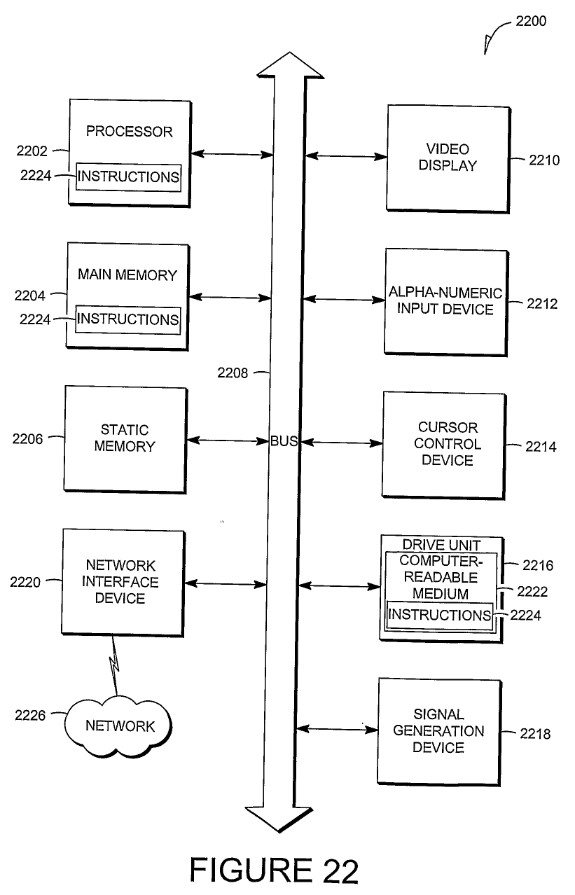

FIG. 22 shows a diagrammatic representation of machine in the exemplary form of a computer system 2200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an MP3 player), a car audio device, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 2200 includes a processor 2202 (e.g., a central processing unit (CPU) a graphics processing unit (GPU) or both), a main memory 2204 and a static memory 2206, which communicate with each other via a bus 2208. The computer system 2200 may further include a video display unit 2210 (e.g., a liquid crystal display (LCD) or a cathode ray tube (CRT)). The computer system 2200 also includes an alphanumeric input device 2212 (e.g., a keyboard), a cursor control device 2214 (e.g., a mouse), a disk drive unit 2216, a signal generation device 2218 (e.g., a speaker) and a network interface device 2230.

The disk drive unit 2216 includes a machine-readable medium 2222 on which is stored one or more sets of instructions (e.g., software 2224) embodying any one or more of the methodologies or functions described herein. The software 2224 may also reside, completely or at least partially, within the main memory 2204 and/or within the processor 2202 during execution thereof by the computer system 2200, the main memory 2204 and the processor 2202 also constituting machine-readable media.

The software 2224 may further be transmitted or received over a network 2226 via the network interface device 2230.

While the machine-readable medium 2222 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

The embodiments described herein may be implemented in an operating environment comprising software installed on a computer, in hardware, or in a combination of software and hardware.

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus comprising:
media metadata for a plurality of media items, the media metadata comprising a plurality of strings, wherein each string describes an aspect of the media items; and
phonetic metadata associated with the plurality of strings, each portion of the phonetic metadata stored in an origin language of the string.

2. The apparatus of claim 1, wherein media items are selected from at least one of compact discs, digital audio tracks, digital versatile discs, movies, or photographs.

3. The apparatus of claim 1, wherein the aspect of the media items are selected from at least one of a media title, a primary artist name, a track title, a command, or a provider.

4. The apparatus of claim 4, wherein the origin language of the string includes a language in which the string would be spoken.

5. An apparatus with memory to store a data structure comprising:
a first field comprising a display text, the display text comprising text suitable for display; and
a second field comprising an official phonetic transcription of the display text stored in a source language of the display text.

6. The apparatus of claim 5, wherein the second field further comprises one or more alternate phonetic transcriptions of the display text.

7. The apparatus of claim 6, wherein the one or more alternate phonetic transcriptions of the display text comprises:
at least one of one or more correct pronunciation phonetic transcriptions or one or more incorrect pronunciation phonetic transcriptions.

8. The apparatus of claim 5 further comprising:
a written language identification (ID) indicating an origin written language of the display text.

9. The apparatus of claim 5 further comprising:
an official representation flag to indicate whether the display text is an official representation or an alternate representation.

10. The apparatus of claim 9, wherein the official representation is at least one of text that appears on an officially released media or editorially decided, and the alternate representation is at least one of a nickname, a short name, or a common abbreviation.

11. The apparatus of claim 9, further comprising an origin language transcription flag associated with each phonetic transcription of the second field, wherein the origin language transcription flag indicates if the phonetic transcription corresponds to the written language ID.

12. The apparatus of claim 5, further comprising a correct pronunciation flag associated with each phonetic transcription of the second field, wherein the correct pronunciation flag indicates if the phonetic transcription is a correct pronunciation or a mispronunciation of the display text.

13. The apparatus of claim 5, wherein the display text is selected from at least one of a media title, a primary artist, a track title, a track primary artist name, a command array, or a provider.

14. A method comprising:
accessing a plurality of strings of media metadata; and
creating at least one official phonetic transcript for each of the plurality of strings in an origin language of each string.

15. The method of claim 14, further comprising:
assigning a spoken language identification (ID) to each of the plurality of strings, the spoken language ID indicating an origin language of each of the plurality of strings.

16. The method of claim 14, wherein the plurality of strings are each a representation of display text, the method further comprising:
selecting at least one of a media title, a primary artist, a track title, a track primary artist name, a command array, or a provider as the display text.

17. The method of claim 15, further comprising:
creating at least one alternate phonetic transcript for at least a portion of the plurality of strings in a non-origin language of each string.

18. A method comprising:
recognizing a media item with a digital fingerprint to obtain metadata for the media item; and
accessing media metadata and associated phonetic metadata for the media item, the phonetic metadata comprising at least one phonetic transcription in an origin language of the media item.

19. The method of claim 18, further comprising:
configuring the media metadata and the associated phonetic metadata for an application.

20. The method of claim 18, further comprising:
selecting at least one of music metadata, playlisting metadata or navigation metadata as the media metadata.

21. The method of claim 18, further comprising:
providing the associated phonetic metadata to a device during access of the media item.

22. The method of claim 18, further comprising:
reproducing the associated phonetic metadata with speech synthesis during access of the media item.

23. A method comprising:
matching a converted text string with a media item;
processing the converted text through an alternate phrase mapper to identify a string associated with an official phonetic transcription for the converted text string of the media item; and

24. The method of claim 23 further comprising:
providing the string associated with an official phonetic transcription for the media item for use by an application.

25. The method of claim 24 further comprising:
processing a command using the string associated with an official phonetic transcription on a device running the application.

26. The method of claim 23 further comprising:
obtaining a phrase; and
converting the phrase to a converted text string with speech recognition.

27. A method comprising:
detecting a spoken language of a string and a target application;
accessing a phonetic transcription associated with the string; and
providing the phonetic transcription associated with the string in the spoken language of the target application.

28. The method of claim 27 further comprising:
reproducing the phonetic transcription of the string through speech synthesis.

29. The method of claim 27 further comprising:
accessing a string, wherein the string comprises display text of at least one of a media title, a primary artist, a track title, a track primary artist name, a command array, or a provider.

30. The method of claim 27, wherein accessing a phonetic transcription associated with the string comprises:
accessing a regionalized phonetic transcription associated with the string when a regionalized exception is available for the spoken language of the target application.

31. The method of claim 27 further comprising:
generating a phonetic transcription for the string in the spoken language of the target application using G2P.

32. The method of claim 27 further comprising:
generating a phonetic transcription for the string in the spoken language of the string; and
converting the phonetic transcription into the spoken language of the target application using a phoneme conversion map.

33. The method of claim 27 further comprising:
converting the phonetic transcription into the spoken language of the target application.

34. The method of claim 27 further comprising:
accessing a phonetic language conversion map for the phonetic transcription; and
converting the phonetic transcription into a language of the application using the phonetic language conversion map.

35. The method of claim 27 further comprising:
reproducing the phonetic transcription with an embedded application of a playback device.

36. A machine-readable medium comprising instructions, which when executed by a machine, cause the machine to:
access a plurality of strings of media metadata; and
create at least one official phonetic transcript for each of the plurality of strings in an origin language of each string.

37. The machine-readable medium of claim 36, further comprising instructions, which when executed by a machine, cause the machine to:
create at least one alternate phonetic transcript for at least a portion of the plurality of strings in a non-origin language of each string.

38. A machine-readable medium comprising instructions, which when executed by a machine, cause the machine to:
match a converted text string with a media item;
process the converted text through an alternate phrase mapper to identify a string associated with an official phonetic transcription for the converted text string of the media item; and
process the string associated with then official phonetic transcription with speech synthesis.

39. A machine-readable medium comprising instructions, which when executed by a machine, cause the machine to:
perform a spoken language detection of a string and a target application;
access a phonetic transcription associated with the string; and
reproduce the phonetic transcription associated with the string in the spoken language of the target application through speech synthesis.

40. The apparatus comprising:
means for accessing a plurality of strings of media metadata; and
means for creating at least one official phonetic transcript for each of the plurality of strings in an origin language of each string.

41. The apparatus of claim 40 further comprising:
means for creating at least one alternate phonetic transcript for at least a portion of the plurality of strings in a non-origin language of each string.
